(19) United States
(12) Patent Application Publication
(10) Pub. No.: US 2007/0132930 A1
(43) Pub. Date: Jun. 14, 2007

(54) Alignment layer rubbing apparatus

(75) Inventors: Sung Guk Ryu, Kyoungki-do (KR); Hae Jin Park, Kyoungki-do (KR)

Correspondence Address: SEYFARTH SHAW LLP, 131 S. DEARBORN ST., SUITE2400, CHICAGO, IL, 60603-5803, US

(73) Assignee: Boe Hydis Technology Co., Ltd.

(21) Appl. No.: 11/637,990

(22) Filed: Dec. 13, 2006

(30) Foreign Application Priority Data
Dec. 14, 2005 (KR) 10-2005-0123263

(51) Int. Cl. D01F 11/02; B24B 51/00; G02F 1/1337

(52) U.S. Cl. 349/126; 264/208; 451/5

(57) ABSTRACT

Disclosed is an alignment layer rubbing apparatus including a table for seating a glass substrate and a rubbing roller movably positioned on top of the table so as to rub an alignment layer of the glass substrate seated on the table. The table and the rubbing roller are tilted at a predetermined angle, and the rubbing roller is adapted to move at an angle of 0° on the table. Therefore, the damage inflicted on the alignment layer due to poor aligning of rubbing fabric attached to the rubbing roller or due to the existence of an alien substance on a surface of the rubbing roller is not concentrated, but rather spans across a region. This reduces the occurrence of rubbing stains and the visibility of damaged parts.

### BACKGROUND OF THE INVENTION

1. Field of the Invention

The present invention relates to an alignment layer rubbing apparatus, and more particularly to an alignment layer rubbing apparatus capable of minimizing a rubbing defect of an alignment layer resulting from, for example, an alien substance attached to a rubbing roller during an alignment layer rubbing process for determining the initial alignment direction of liquid crystal molecules in an LCD.

2. Description of the Prior Art

As generally known in the art, an LCD is an electronic device adapted to convert various types of electric information, which is created by different devices, into visual information by using the change of transmittance of liquid crystals, which depends on the applied voltage, and display corresponding images. LCDs are used as the information display window of portable terminals and laptop computers, for example.

The LCD includes an upper glass substrate, a lower glass substrate, and a liquid crystal layer interposed between the upper and lower glass substrates. The alignment angle of liquid crystal molecules, which constitute the liquid crystal layer, varies in conformity with the applied voltage, in order to adjust the degree of transmittance of light through the liquid crystal layer or block light, for the sake of screen display.

The initial alignment direction of the liquid crystal molecules depends on the rubbing direction and condition of the alignment layer, with which the upper and lower glass substrates are coated.

FIG. 1 shows an alignment layer rubbing apparatus 10 used in a process for defining the rubbing direction of an alignment layer. The apparatus 10 includes a table 12, on which a glass substrate 11 is seated, and a rubbing roller 13 positioned on top of the table 12 so as to form a groove on an alignment layer (not shown) of the glass substrate 11. Alignment layer rubbing processes include a 0° rubbing process wherein the rubbing roller 13 and the table 12 are positioned at an angle of 0° (i.e. horizontally), and the rubbing roller 13 or the table 12 is moved at an angle of 0° (i.e. horizontally) so that a groove is formed on the alignment layer of the glass substrate 11.

However, if an alien substance 14 exists on a surface of the rubbing roller 13, which makes direct contact with the alignment layer as shown in FIG. 2, a surface of the alignment layer is damaged by the align substance 14 when a groove is formed on the alignment layer.

As rubbing is performed at an angle of 0° (i.e. horizontally), the damage inflicted on the alignment layer by the alien substance 14 is reflected by a defect 15 occurring in a continuous line pattern.

The defect 15 occurring on the alignment layer in a continuous line pattern causes irregular formation of a groove on the alignment layer, as well as scratches thereon. When the upper and lower glass substrates are assembled for an on/off test, the defect 15 on the upper glass substrate overlaps that on the lower glass substrate. As a result, a rubbing stain is generated, and the visibility of the defect 15 is increased. This degrades the display quality of the LCD.

### SUMMARY OF THE INVENTION

Accordingly, the present invention has been made to solve the above-mentioned problems occurring in the prior art, and an object of the present invention is to provide an alignment layer rubbing apparatus capable of preventing a defect from occurring on an alignment layer in a continuous line pattern due to an alien substance during an alignment layer rubbing process.

In order to accomplish this object, there is provided an alignment layer rubbing apparatus including a table for seating a glass substrate and a rubbing roller movably positioned on top of the table so as to rub an alignment layer of the glass substrate seated on the table, wherein the table and the rubbing roller are tilted at a predetermined angle, and the rubbing roller is adapted to move at an angle of 0° on the table.

Preferably, the predetermined angle falls within a range of 1° to 15° or −1° to −15°.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram briefly showing a conventional alignment layer rubbing apparatus;

FIG. 2 is a block diagram showing a defect pattern created on a glass substrate when the alignment layer rubbing apparatus shown in FIG. 1 is operated;

FIG. 3 is a block diagram briefly showing an alignment layer rubbing apparatus according to an embodiment of the present invention;

FIG. 4 is a block diagram showing a defect pattern created on a glass substrate when the alignment layer rubbing apparatus shown in FIG. 3 is operated; and

FIG. 5 is a top view showing a defect pattern resulting from assembly of upper and lower glass substrates having the same defect pattern as shown in FIG. 4.

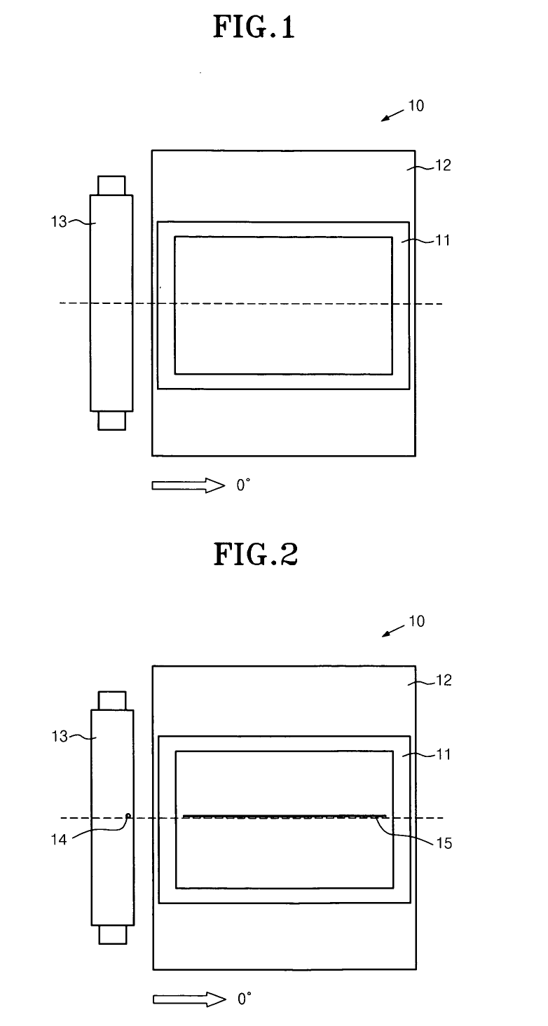

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

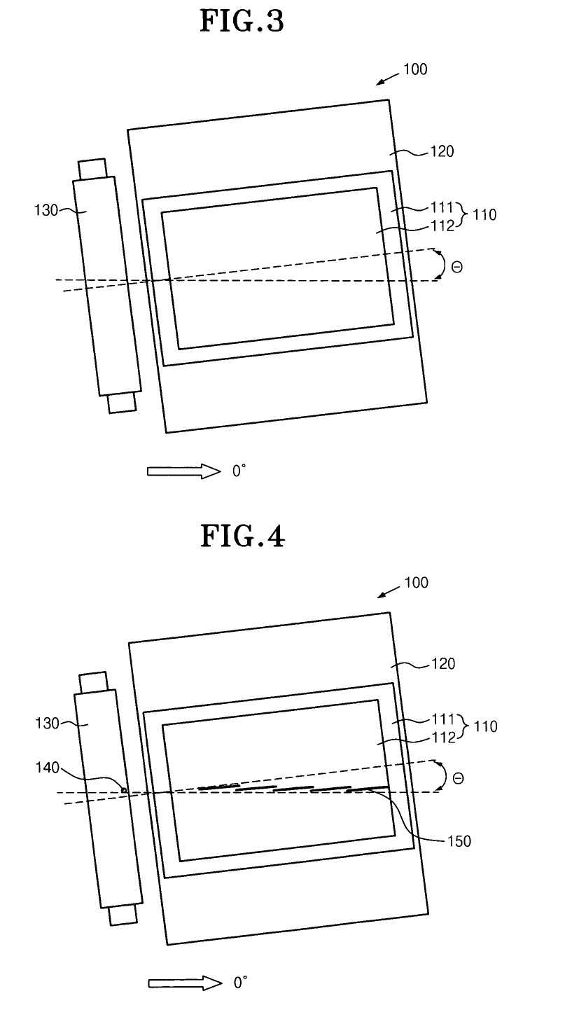

FIG. 3 is a block diagram briefly showing an alignment layer rubbing apparatus according to an embodiment of the present invention.

Referring to the drawing, the alignment layer rubbing apparatus 100 includes a table 120, on which a glass substrate 110 is seated, and a rubbing roller 130 positioned on top of the table 120 and adapted to move horizontally.

The table 120 and the rubbing roller 130 are initially positioned parallel to each other and are tilted at a predetermined angle relative to the horizontal direction, preferably at an angle of 1° to 15° or −1° to −15°.

If the tilt angle is less than ±1°, there is little improvement over the conventional configuration (wherein the angle is 0°). This means that a defect occurs on the alignment layer in a continuous line type due to an alien substance. If the tilt angle is larger than ±15°, a dummy region 111 occupies a considerable area of the glass substrate 110. This degrades the efficiency of utilization of the glass substrate 110 (the glass substrate 110 has an active region 112 defined at its center and a dummy region 111 defined around the active region 112).

The range of the tilt angle of the table 120 and the rubbing roller 130, as given above, depends on the size of the dummy region 111 of the glass substrate 110. In the case of a 10.4 inch or 20.8 inch glass substrate 110, the dummy region 111 has a size of 22 mm, and the tilt angle is about 3°.

After the table 120 and the rubbing roller 130 are positioned parallel to each other and tilted at an angle in this manner, one of them is moved in the horizontal direction (i.e. at an angle of 0°) so that the alignment layer of the glass substrate 110 can be rubbed.

For example, when the table 120 and the rubbing roller 130 have been tilted at an angle of 30, the rubbing roller 130 is rotated by an angle of −3° and moved in the horizontal direction (i.e. at an angle of 0°).

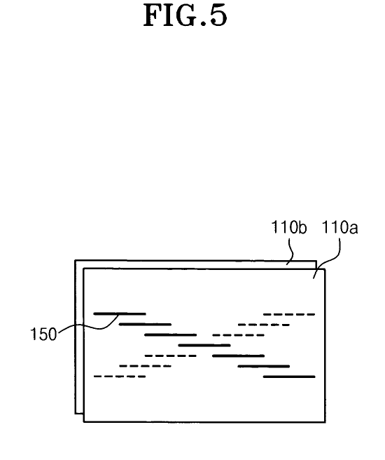

Consequently, when an alien substance 140 exists on a surface of the rubbing roller 130 as shown in FIG. 4, the damage inflicted on the alignment layer by the alien 10 substance 140 is not reflected by a defect occurring on the alignment layer in a continuous line pattern as in the case of the prior art, but by a defect 150 occurring in a step pattern. This means that damage to the alignment layer is not concentrated, but rather spans across a region. When the upper and lower glass substrates 110a and 10b are assembled together as shown in FIG. 5, the damage inflicted on the alignment layer of each substrate is reflected by a defect 150 occurring in a cross pattern without overlapping.

As a result, during an on/off test, the level of visibility of the rubbing stain or defect 150, which reflects damage to the alignment layer, is reduced.

In summary, the alignment layer rubbing apparatus 100 is operated as follows: the table 120 and the rubbing roller 130 are tilted at an angle, and one of them is rotated by the same angle as the tilt angle but in the opposite direction so that it is moved at an angle of 0°. As a result, damage to the alignment layer resulting from an alien substance 140 on a surface of the rubbing roller 130, for example, is not concentrated, but rather spans across a region. This reduces the occurrence of rubbing stains and the visibility of damaged parts.

As mentioned above, the alignment layer rubbing apparatus according to the present invention is advantageous in that, by tilting the table and the rubbing roller at an angle and rotating one of them by the same angle as the tilt angle but in the opposite direction so that it is moved at an angle of 0°, the damage inflicted on the alignment layer due to poor alignment of rubbing fabric attached to the rubbing roller or due to the existence of an alien substance on a surface of the rubbing roller is not concentrated, but rather spans across a region. This reduces the occurrence of rubbing stains and the visibility of damaged parts.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An alignment layer rubbing apparatus comprising:
a table for seating a glass substrate and
a rubbing roller movably positioned on top of the table so as to rub an alignment layer of the glass substrate seated on the table, wherein the table and the rubbing roller are tilted at a predetermined angle, and the rubbing roller is adapted to move at an angle of 0° on the table.

2. The alignment layer rubbing apparatus as claimed in claim 1, wherein the predetermined angle falls within a range of 1° to 15° or −1° to −15°.
